(19) United States
(12) Patent Application Publication
(10) Pub. No.: US 2026/0005590 A1
(43) Pub. Date: Jan. 1, 2026

(54) LINEAR ACTUATOR AND METHOD OF OPERATION

(71) Applicant: TITAN HAPTICS INC., Mississauga (CA)

(72) Inventor: Timothy Jing Yin SZETO, Mississauga (CA)

(21) Appl. No.: 19/111,935

(22) PCT Filed: Sep. 20, 2023
(86) PCT No.: PCT/CA2023/051243

§ 371 Date: Mar. 14, 2025

Related U.S. Application Data
(60) Provisional application No. 63/412,970, filed on Oct. 4, 2022.

(51) Int. Cl. H02K 33/18

(52) U.S. Cl. CPC H02K 33/18

(57) ABSTRACT

A linear actuator device is provided. The device has a housing defining a displacement path and a mass movably mounted within the housing. The housing has a plurality of force element locations at which a force element can be held. When the mass is displaced from a rest position, a return force is generated by interaction of the force elements and the mass in accordance with a force response curve. The characteristics of the force response curve vary depending on the force element location at which the force element is positioned. The force element may be moved between different force element locations.

### FIELD

This specification relates to linear actuator devices.

### BACKGROUND

Linear actuators typically involve some form of mass which is movable back and forth in a linear path. Linear actuators involve some form of drive element which can exert a driving force onto the mass and cause changes in movement speed and movement orientation. In the case of an electromagnetic actuator, the drive element can be a coil and the mass can have a permanent magnet configuration associated to it to react to changes in the magnetic field generated by the coil, for instance. The changes in movement speed and movement orientation are associated to acceleration forces, and back and forth movement generates vibrations. Such linear actuators can have a reactive force path, e.g. a path which causes a progressively varying force response as the mass is moved within it, away from an equilibrium position or zone where no force is exerted. By analogy with the plotting of a value of force exerted on the mass by the reactive force path as a function of position, the reactive force path can be said to have a force response curve.

In the case of haptics actuators, the force response curve exhibits a return force when the mass is moved away from the equilibrium position. Moreover, the characteristics of the force response curve may be such that the reactive force produced progressively increases with the distance from the equilibrium position.

Although existing linear actuators were satisfactory to a certain degree, there always remains room for improvement.

### SUMMARY

Manufacturing a haptic actuator system may be a complicated process, particularly as the size of the system becomes increasingly small, as is often required for modern applications (e.g. within mobile electronic devices, for example, as depicted in FIG. 2). Once manufactured, the haptic actuator system may have a set force response curve along the reactive force path. A haptic actuator manufacturer may specialize in manufacturing haptic actuators, and may sell their haptic actuator to different electronic device manufacturers. As different devices and/or models of devices may have different physical dimensions and design constraints, it may not be possible to use the same haptic actuator system design within multiple different devices and achieve the same desired force response characteristics. This may lead to inefficient manufacturing processes, as each haptic actuator system may require its own unique manufacturing process for use within different devices, which may increase production costs. A haptic actuator manufacturer may desire a single model of haptic actuator, being industrially produced in a manner to reduce production costs, easily adaptable to different situations and devices. A haptic actuator system capable of a single manufacturing process and having a force response curve that can be adjusted subsequently after manufacturing would be desirable.

Moreover, modern electronic devices may require multiple different haptic feedback response profiles when performing different tasks or using different applications on a mobile device. For example, the desired haptic feedback response to receiving a keystroke on a touchscreen keyboard on a mobile device may be different from the desired haptic feedback response when playing a video game on the same mobile device. The need for multiple distinct haptic response profiles may require multiple different haptic actuators within a device. It would be beneficial to be able to adjust the force response curve characteristics of a single haptic actuator system to meet the needs of different applications rather than using multiple different haptic actuators.

In accordance with a first aspect, there is provided an actuator device comprising: a housing defining a linear displacement path; a mass movably mounted in the housing in the linear displacement path, the mass having a magnetic segment; an electromagnet fixed relative to the housing and configured to selectively impart an acceleration to said mass in an orientation of said linear displacement path; a reactive force path generating a return force when the mass is displaced from a rest position, the return force being in the orientation of the linear displacement path towards the rest position, an amplitude of the return force varying as a function of a position of the mass in the linear displacement path in accordance with a force response curve, the force response curve defining a frequency response curve in relationship with the frequency of movement of the mass in the linear displacement path; the housing having a plurality of force element locations for receiving a force element of the reactive force path, a peak response frequency of the frequency response curve varying from of the force element locations to another, the force element being held at one of the force element locations.

In accordance with another aspect, there is provided a method of operating an actuator device having a mass movably mounted in a linear displacement path defined relative a housing, the actuator device further having a reactive force path having a plurality of force elements including at least one force element having a plurality of locations defined relative the housing, the method comprising: imparting a time-varying drive force to the mass in an orientation of the linear displacement path at a first drive frequency, the reactive force path imparting a return force to the mass when the mass is displaced along the linear displacement path away from a rest position, the return force being in the orientation of the linear displacement path and towards the rest position, the amplitude of the return force varying as a function of the position of the mass in the linear displacement path in accordance with a force response curve, the force response curve defining a frequency response curve for the mass in the linear displacement path, moving said at least one force element from a first one of said plurality of locations to a second one of said plurality of locations; said imparting of the time-varying drive force and the imparting of the return force oscillating the mass within the linear displacement path at a first oscillation frequency when the at least one force element is at the first one of said plurality of locations, and oscillating the mass within the linear displacement path at a second oscillation frequency when the at least one force element is at the second one of the plurality of locations.

In accordance with another aspect, there is provided a method of assembling an actuator device having a mass movably mounted in a linear displacement path defined relative a housing, the actuator device further having a reactive force path having a plurality of force elements including at least one force element having a plurality of locations defined relative the housing, the method comprising: selecting, from amongst a plurality of spacers having different thicknesses associated to different ones of said plurality of locations, one of said spacers corresponding to a respective one of said plurality of locations; sandwiching said selected spacer between a corresponding one of said force elements and a stop of the housing, said selected spacer setting a location of the force element to said one of said plurality of locations.

Many further features and combinations thereof concerning the present improvements will appear to those skilled in the art following a reading of the instant disclosure.

### DESCRIPTION OF THE FIGURES

In the figures,

FIG. 1A is a schematic, simplified view of a example linear actuator, FIG. 1B presents the force response curve thereof, and FIG. 1C presents the frequency response curve thereof;

FIG. 2A is block diagram of an example device incorporating a controller and a linear actuator;

FIG. 2B is a block diagram of an example computing device;

FIG. 3A is schematic diagram of an example linear actuator device contained within a housing with a first force element configuration;

FIG. 3B is a schematic diagram of the example linear actuator device of FIG. 3A with a second force element configuration;

FIG. 3C presents the frequency response curves of the devices of FIGS. 3A and 3B;

FIG. 4A is a schematic diagram of an example linear actuator device;

FIG. 4B is a schematic diagram of the linear actuator device of FIG. 4A with adjustable position elements in a second configuration;

FIG. 5A is a cross-sectional side view of an example linear actuator device;

FIG. 5B is a perspective view of the interior of the example linear actuator device depicted in FIG. 5A;

FIG. 5C is a cross-sectional side view of the example linear actuator device depicted in FIG. 5A with a force element in a first location;

FIG. 5D is a cross-sectional side view of the example linear actuator device depicted in FIG. 5A with a force element in a second force element location;

FIG. 6 is a cross-sectional side view of an example linear actuator device including one or more spacing elements; and

FIG. 7 is a flow chart depicting an example method of operating an actuator device.

### DETAILED DESCRIPTION

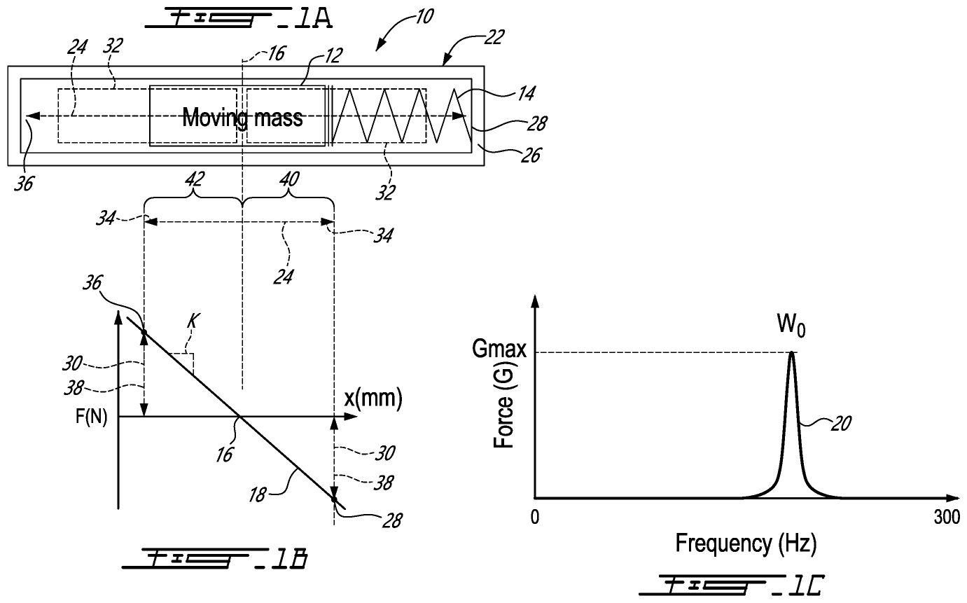

FIG. 1A shows a relatively simple example of a linear actuator 22 which can be used for providing haptics feedback. Using this example, some language useful for the description of other linear actuators which will follow will be introduced. The linear actuator 22 can be said to generally include a mass 12 which can be moved linearly back and forth along a linear path 24. The linear path 24 can be defined by a linear guide, such as by being circumscribed by a housing 26 defining a linear path 24 longer than the mass 12 for instance, in which the mass 12 can be slidingly engaged.

The linear actuator 22 also includes some form of drive force generator (not shown) which is configured for selectively imparting a drive force, or not, onto the mass 12 to spur its movement along the linear path 24. In the case where the mass 12 has one or more magnetic segment(s), the drive force generator can be an electromagnet which is magnetically coupled to a permanent magnetic field of the mass 12, for instance, but other forms of drive force generator, or ways of driving the movement of the mass, may be preferred in other embodiments.

The linear actuator 22 is further provided with a reactive force path which, in the example presented in FIGS. 1A to 1C, is entirely provided by means of a compression spring 14 which is secured between the mass 12 and the housing 26 at one end 28. In this embodiment, the compression spring 14 has a spring constant k which can remain constant along the entire span of displacement along the linear path 24, and therefore generate a linear force response curve 18 (FIG. 1B). The force response curve 18 of the reactive force path 32, represented here by dashed boxes in FIG. 1A, is presented in FIG. 1B. As shown on the left hand side of the rest position 16 of FIG. 1B, the reactive force path 32 generates a progressively (linearly) increasing return force 30. The farther the mass is moved along the linear path from the rest position 16 towards the left, the more the spring 14 is stretched, following a typical mass/spring behaviour, governed by the equation F=kx (where x is displacement). As shown on the right hand side of the rest position 16 of FIG. 1B, the reactive force path 32 offers a progressively increasing return force 30 the farther the mass is moved towards the right from the rest position 16, compressing the spring 14.

In this case, the force response curve 18 is linear, in the sense that it has a constant slope k, and the force response is proportional to the distance from the rest position 16. Since the maximum extent of the linear displacement path 34 and the amplitude of the maximum displacement 34 can vary from one embodiment to another, it may be practical to provide values of slope k in relative units. Indeed, independently of the embodiment, the linear displacement path 24 can have a static rest position 16, also known as an equilibrium position, from which the mass 12 can be moved by the drive force generator in two directions, to corresponding ends 28, 36 of the linear displacement path 24. The ends 28, 36 of the linear displacement path 24 can be defined by the reactive force path, and can even be delimited by hard stops for instance, or can be defined by properties such as the maximum force and frequency of the drive force generator, and friction, which can be translated into a maximum extent of displacement at perfect resonance for instance. The maximum force 38 and the maximum extent/span of displacement 34 are thus properties of a given linear actuator independently of the details of implementation. To define normalized units, let us define units in which half of the full span of the linear displacement path 24 is equal to the maximum return force 38. For example ½ of the maximum extent of displacement 34 can have a value of 1 in units of maximum displacement, and the maximum return force 38 exerted by the reactive force path can have a value of 1 in units of maximum return force 38. The slope can thus be expressed in units of increasing force per units of increasing displacement. In the context of a linear reactive force path, using the definition presented above, the slope remains constantly equal to 1 in these units along the entire extent of displacement, on either side of the rest position 16. The slope is also 1 at the rest position 16, clearly defining the static rest position 16. The force response curve 18 is also symmetrical, providing an equal return force 30 independently of the mass position orientation relative to the equilibrium position 16.

The shape of the force response curve 18 is thus also a property of the linear actuator, and will be defined by the force element(s) of the reactive force path. In this embodiment of FIG. 1A, there is a single force element, the compression spring 14, which entirely defines the force response curve 18 but it is understood that other embodiments (e.g. embodiments in which the force element(s) is/are one or more magnet(s), one or more spring(s), and/or combinations thereof) can be used in alternate embodiments, examples of which will be presented below.

The shape of the force response curve 18 will entrain dynamic effects which can be visualized during operation. In this example, for instance, the force response curve 18 includes a first region 40 of increasing return force 30 extending from the rest position 16 to the first end 28 of the linear displacement path 24, on a first side of the rest position 16, and a second region 42 of increasing return force 30 extending from the equilibrium position 16 to the second end 36 of the linear displacement path 24, on a second side of the equilibrium position 16. The two regions 40, 42 of increasing return force 30 define the entirety of the force response curve 18. The return force 30 always acts in the orientation of the displacement, which can be due to the fact that the linear displacement path 24 constrains the movement within that orientation, but acts in opposite directions depending on the side relative to the rest position 16, and thus always acting in a manner to return the mass 12 to the rest position 16, hence the expression “return” force.

If moved to one side against the return bias of the spring 14, and suddenly freed from the external force, the spring 14 will pull the mass 12 back past the rest position 16, an the mass 12 will oscillate back and forth around the rest position 16 for a certain amount of time before its energy is dissipated in friction and the mass 12 settles back at the ‘static’ rest position 16 (which can be a region instead of a point in a non-linear system, but a point is typically preferred in haptics). The frequency at which the mass 12 will oscillate back and forth is the natural frequency of the linear actuator, and will be denoted herein as W₀. W₀ depends, in the simplified case of a force response curve having constant slope presented in FIG. 1B, on the slope of the force response curve 18 which, in this embodiment, is directly related to the spring constant k. If the drive force generator is configured to provide drive energy repetitively into the system 10 at a frequency close to the natural frequency W₀, which can be done by operating a coil with alternating current for instance, the repetitively added energy will add up into a “resonance”, and the moving mass 12 will reach greater and greater amplitudes of displacement and acceleration until it meets a dynamic equilibrium oscillation, in which the energy losses due to friction will correspond to the amount of energy introduced into the system at each cycle.

The expression “provide drive energy repetitively into the system at a frequency close to the natural frequency” may be best understood by referring to FIG. 1C. FIG. 1C presents a graph which shows the force (acceleration) response spectrum 20 of the linear actuator 22 of FIG. 1A as a function of drive frequency, for a given drive energy amplitude. Indeed, if the same amount of energy is provided to the mass 12, but at a different frequency than W₀, the mass 12 will still be driven but some of the energy will not be efficiently transferred into movement since the movement of the spring 14 will not resonate with the drive and as such, the amplitude of acceleration and displacement of the mass 12 driven by the drive force will be lesser. Indeed, the peak shown in the frequency response graph corresponds with the frequency W₀. One can see that the force response generated will diminish progressively as the drive frequency is shifted farther and farther away from the natural frequency W₀.

In a context where the drive force generator has a maximal drive force generator value (maximum amount of drive energy), which, in the case of an electromagnet (coil) drive can correspond to a maximum voltage for instance, the maximal drive force generator will only produce the maximal acceleration response value Gmax if its maximum voltage input is correctly timed to oscillate between positive and negative at the natural frequency W₀, and the maximal drive force generator value will generate a smaller acceleration response the farther away it is operated from the natural frequency W₀, and in this example of FIG. 1C a shift of ⅕^{th} in frequency from W₀ will produce only a negligible acceleration response, perhaps below 5% of the maximum acceleration response value. In some embodiments described herein, the frequency response characteristics (e.g. the natural frequency Wₒ) of a linear actuator 22 can be selected and/or changed by moving a force element from one location to another. In some embodiments described herein, the frequency response characteristics may include more than one peak frequency.

Here again, since the frequency response spectrum 20 is defined by the force response curve 18, which in turn in defined by the force element(s) which define the reactive force path, the frequency response spectrum 20 of a linear actuator 22 can be said to be a property of the linear actuator, similarly to how the force response curve 18 can be a property of the linear actuator 22 or the details of the force element(s) are properties of the linear actuator 22.

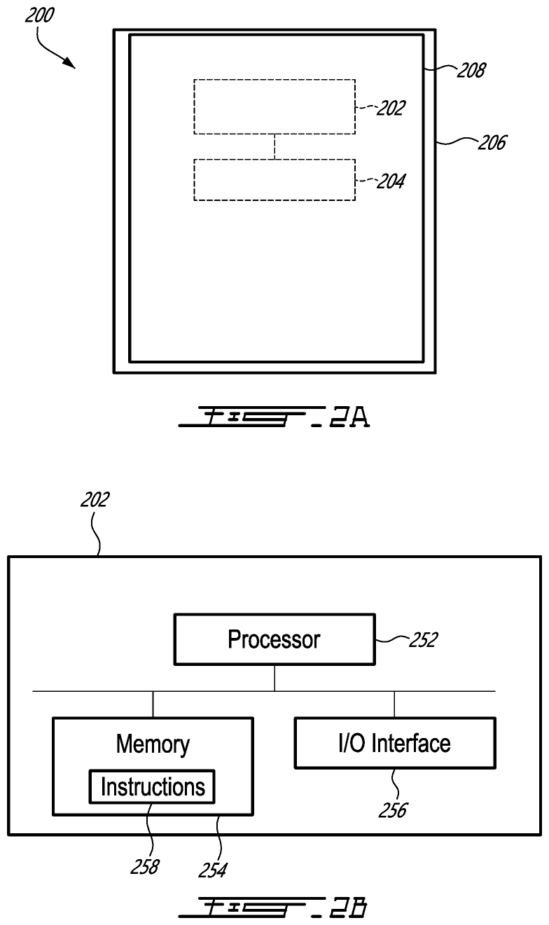

Linear actuators have uses across many different areas of technology and industry. FIG. 2A is a schematic view of an example electronic device 200 incorporating a computing device 202 and a linear actuator 204. In some embodiments, computing device 202 can be used to control operation of linear actuator 204. In some embodiments, computing device 202 may be a controller. In this particular example embodiment, electronic device 200 is a mobile phone 206 having a screen 208. It will be appreciated that device 200 can be any other type of electronic device, which may include or omit screen 208.

FIG. 2B is a block diagram illustrating components of an example computing device 202. As depicted, computing device 202 includes a processor 252, a memory 254, and an input/output interface 256.

Processor 252 can be embodied in the form of a general-purpose microprocessor or microcontroller, a digital signal processing (DSP) processor, an integrated circuit, a field programmable gate array (FPGA), a reconfigurable processor, a programmable read-only memory (PROM), and many other designs.

Memory 254 can include a suitable combination of any suitable type of computer-readable memory located either internally, externally, and accessible by the processor in a wired or wireless manner, either directly or over a network such as the Internet. A computer-readable memory can be embodied in the form of random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) to name a few examples.

A computing device 202 can have one or more input/output (I/O) interface 256 to allow communication with a human user and/or with another computer via an associated input, output, or input/output device such as a keyboard, a mouse, a touchscreen, an antenna, a port, etc. Each I/O interface can enable the computer to communicate and/or exchange data with other components, to access and connect to network resources, to serve applications, and/or perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, Bluetooth, WiMAX), SS7 signaling network, fixed line, local area network, wide area network, to name a few examples.

It will be understood that a computing device 202 can perform functions or processes via hardware or a combination of both hardware and software. For example, hardware can include logic gates included as part of a silicon chip of a processor. Software (e.g. application, process) can be in the form of data such as computer-readable instructions 258 stored in a non-transitory computer-readable memory accessible by one or more processing units. With respect to a computer or a processing unit, the expression “configured to” relates to the presence of hardware or a combination of hardware and software which is operable to perform the associated functions.

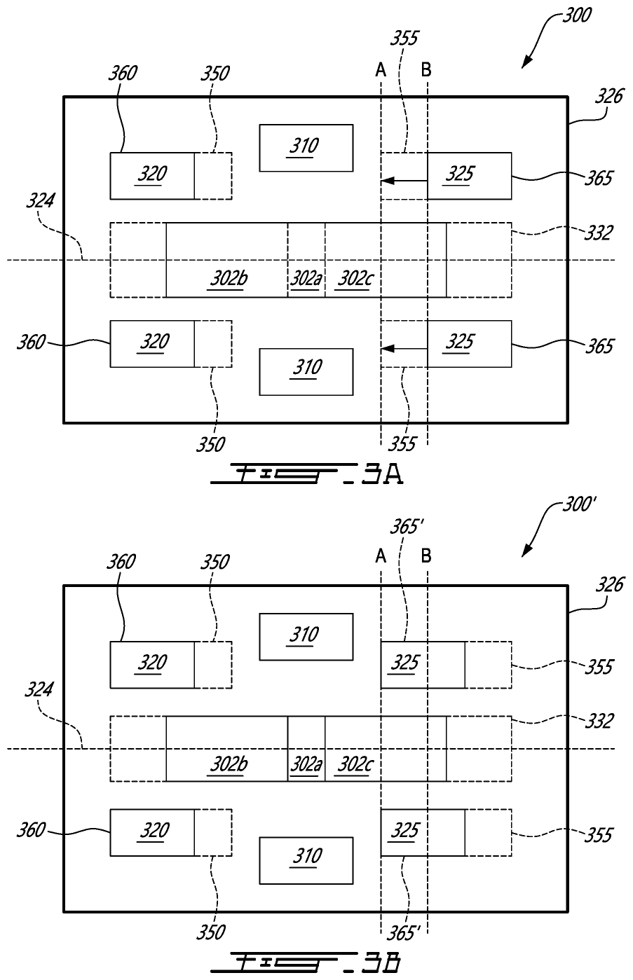

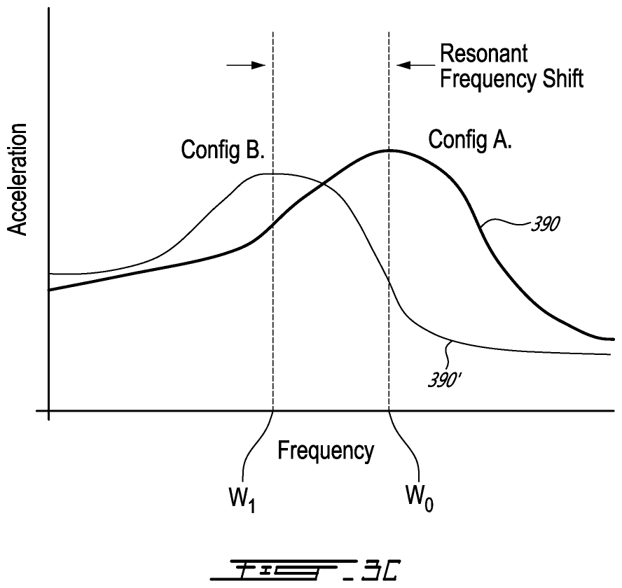

In some embodiments, computing device 202 may be configured to selectively activate and/or deactivate linear actuator 204. For example, computing device 202 may be configured to transmit control signals to, for example, cause an electromagnet to receive a voltage input with the correct timing to oscillate between positive and negative at or near a natural or peak response frequency Wₒ so as to achieve efficient use of the drive energy in imparting an acceleration to the mass. FIG. 3A is schematic diagram of an example linear actuator device 300 which can be used as linear actuator 204 for providing haptics feedback. As depicted, mass 302 is contained within a housing 326 which includes electromagnet 310, and one or more force elements 320, 325 positioned in force element locations 360, 365 respectively. In some embodiments, mass 302 may comprise a ferromagnetic core 302a, and magnets 302b, 302c. In some embodiments, magnets 302b, 302c may be arranged so as to have opposing polarities. Mass 302 can be moved linearly back and forth along linear displacement path 324. The linear path 324 may be circumscribed by housing 326 defining a linear path 326 longer than mass 302 in which mass 302 can be slidingly engaged or otherwise movable.

Electromagnet 310 may be configured to selectively impart a drive force onto mass 302 to spur the movement of mass 302 along linear path 324. In some embodiments, electromagnet 310 may be magnetically coupled to the permanent magnetic fields of magnets 302b, 302c. It will be appreciated that although embodiments described herein relate to a movable mass 302 containing magnetic elements, embodiments are contemplated in which the mass does not include magnetic elements. Similarly, although embodiments describe herein present a mass having a permanent magnet arrangement and a drive force generated by an electromagnet, it will be understood that alternate embodiments can have a drive force generator other than an electromagnet 310.

Linear actuator 300 includes one or more force elements 320, 325 contained within housing 326. As depicted, force element 325 is located within cavity 355 at force element location 365. In some embodiments, force element 325 can be located at any of a plurality of different force element locations 365 within cavity 355. For example, FIG. 3B depicts an example embodiment in which force element 325 is located at force element location 365′ within cavity 355 rather than force element location 365. Likewise, force element 320 may be located in any of a plurality of force element locations 360 within cavity 350. It will be appreciated that although two force elements 320, 325 are depicted in FIGS. 3A and 3B, it is contemplated that some embodiments may omit one of force elements 320, 325.

In some embodiments, force elements 320, 325 may be one or more of spring(s) connected to mass 302, and/or magnet(s) providing a permanent magnetic field which couples with the magnetic field of mass 302, and various combinations thereof. It will be appreciated that comparable force response curves can be implemented using spring elements as force elements, or using magnetic elements as force elements. As such, the force response curve and corresponding frequency response curves associated with linear actuator 300 may be more significant properties than the details of the make or nature of the interaction of force elements 320, 325 with mass 302. Numerous other force element configurations (e.g. force elements including a combination of more than one magnet and/or electromagnet elements with perpendicular or opposite polarities or force elements such as springs or otherwise not electromagnetic in nature) and the corresponding force response curve characteristics and frequency response characteristics are described in International Patent Publication WO 2022/020961.

In some embodiments, varying the location of force elements 320, 325 will affect the force response curve and corresponding frequency response curve of the linear actuator 300. For example, in the case of magnetic force elements, a change in distance between magnets 320, 325 and mass 302 will result in a change in the relative strengths of the magnetic fields as mass 302 changes positions within displacement path 324. Likewise, in the case of one or more spring elements, moving a spring closer to or further away from mass 302 will result in the spring being more compressed or more elongated, which may affect the force response curve. Thus, varying the location 365, 365′ of one or more force elements 320, 325 can affect both the force response curve of linear actuator 300, as well as the amplitude and resonant frequency of the frequency response curve associated therewith.

FIG. 3C presents a frequency response curve 390 associated with linear actuator 300 (having force element 325 located in force element location 365), and a second frequency response curve 390′ associated with linear actuator 300′ (having force element 325 located in a second force element location 365′). As depicted, frequency response curve 390′ has a natural frequency W₁ and peak amplitude which are different from natural frequency W₀ and peak amplitude of frequency response curve 390. As such, it can be said that one or more of the peak response frequency (i.e. the natural frequency) of the frequency response curve 390 of linear actuator 300 may vary as one or more force elements 320, 325 are moved from one force element location 360, 365 to another force element location 360′, 365′ within housing 326.

In some embodiments, housing 326 may be manufactured with a plurality of force element locations available for the subsequent addition of force elements. In this manner, the same housing 326 may be manufactured and be adaptable to different situations and use requirements by allowing for specific positioning of force elements within force element locations to achieve a desired force response curve and/or frequency response curve for a particular application. In this manner, a haptics manufacturer may be able to reduce production costs by standardizing production of a linear actuator and housing, while also meeting the needs of different electronic device manufacturers.

Force element 320, 325 may be held at force element location 360, 365, 365′ by any suitable means. In some embodiments, force element 320, 325 may be held at the force element location 360, 365 by an interference or frictional fit, or any other suitable method of securing an object within a space. In some embodiments, force elements 320, 325 may be fixedly held at force element location 360, 365, 365′ through the use of adhesive. In some embodiments, one or more force elements 320, 325 may be movable between different force element locations.

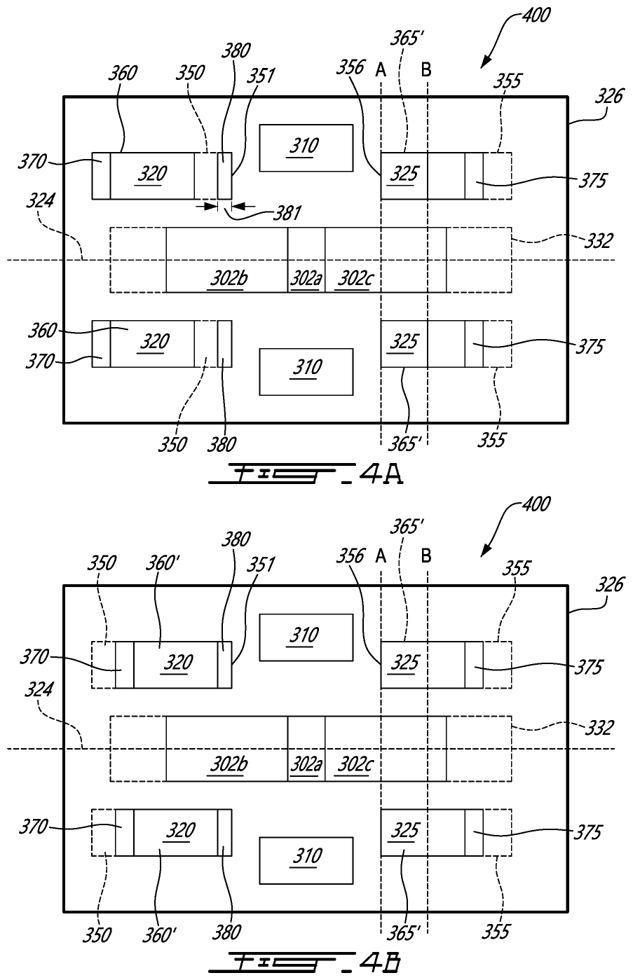

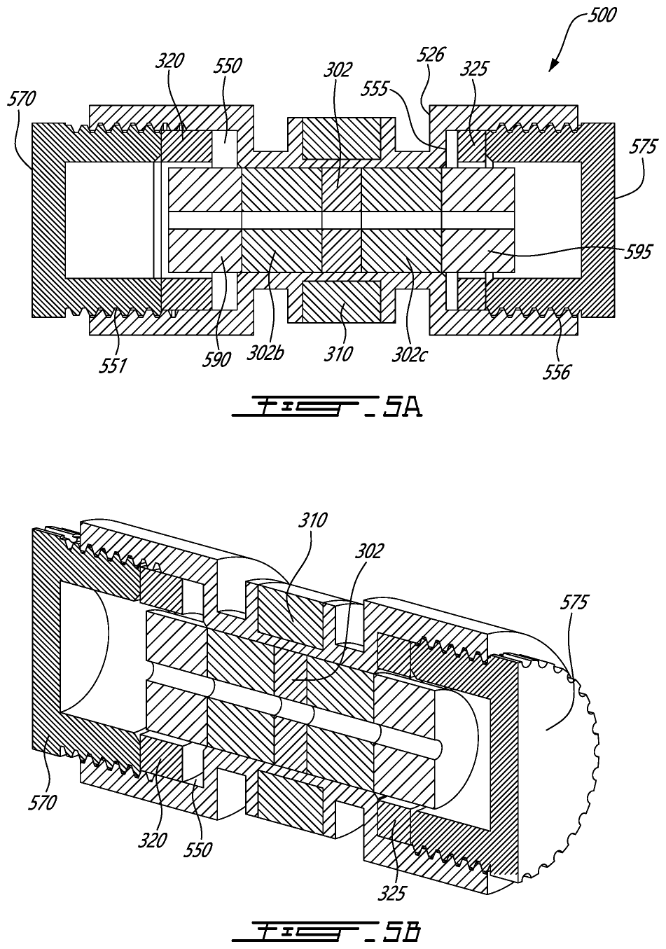

FIG. 4A is a schematic illustration of an example linear actuator device 400 which has one or more adjustable position elements 370, 375. Linear actuator 400 may include many common elements with linear actuator 300, including electromagnet 310, one or more force elements 320, 325, mass 302, and one or more cavities 350, 355 containing a plurality of force element locations 360, 365.

As depicted, force element 325 is mechanically connected or secured to adjustable position element 375 such that movement of adjustable position element 375 results in movement of force element 325 from one force element location 365 to a different force element location 365′. In some embodiments, adjustable position element 375 may be configured for bidirectional movement and can move force element from force element location 365 to force element location 365′ and back to force element location 365 (or to another force element location different from locations 365, 365′ within cavity 355). Likewise, force element 320 may be connected to adjustable position element 370 such that movement of adjustable position element 370 results in movement of force element 320 from one force element location 360 to a different force element location 360′, in a manner similar to adjustable position element 375 with force element 325.

In embodiments in which the force element 325 is a spring, the spring may have two opposite ends, and the first end may be secured to the adjustable position element. Thus, movement of adjustable position element moves a position of the first end. The spring may be mechanically coupled to the mass, and movement of adjustable position element 375 from force element location 365 to force element location 365′ may cause the spring to compress and increase stored potential, and that movement from force element location 365′ to force element location 365 may cause the spring to decompress or stretch to some extent.

Adjustable position element 375 may be operably connected to a mover which controls the movement of adjustable position element 375 (and consequently controls the force element location 365 in which force element 325 is held). In some embodiments, the mover may be an electric motor which may be controlled by controller 202. In some embodiments, the mover may be a manual actuator (e.g. an operator of the device manually adjusting the position of adjustable position element 375). In some embodiments, controller 202 may be operable to alter the force response curve and/or frequency response curve of linear actuator 400 by activating the mover to adjust the position of force element 325 from one force element location 365 to a different force element location 365′.

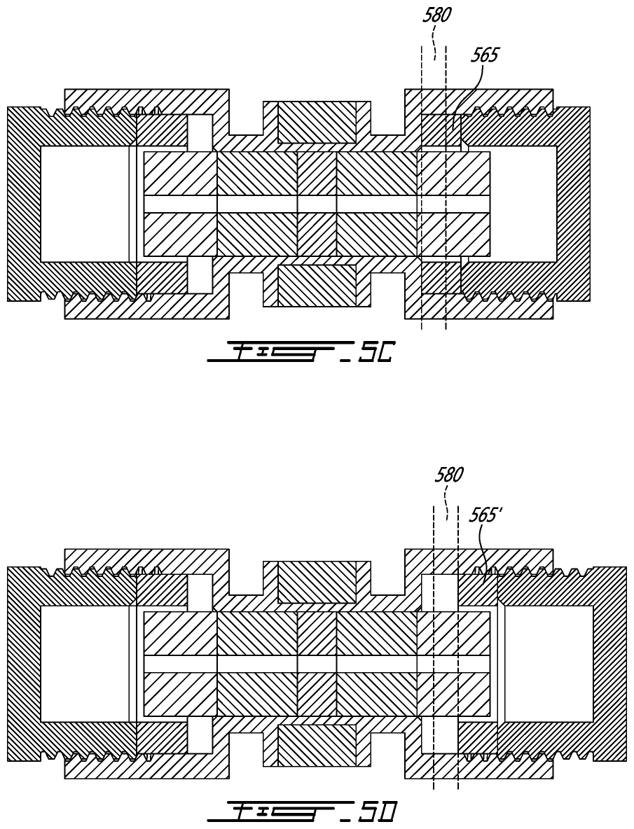

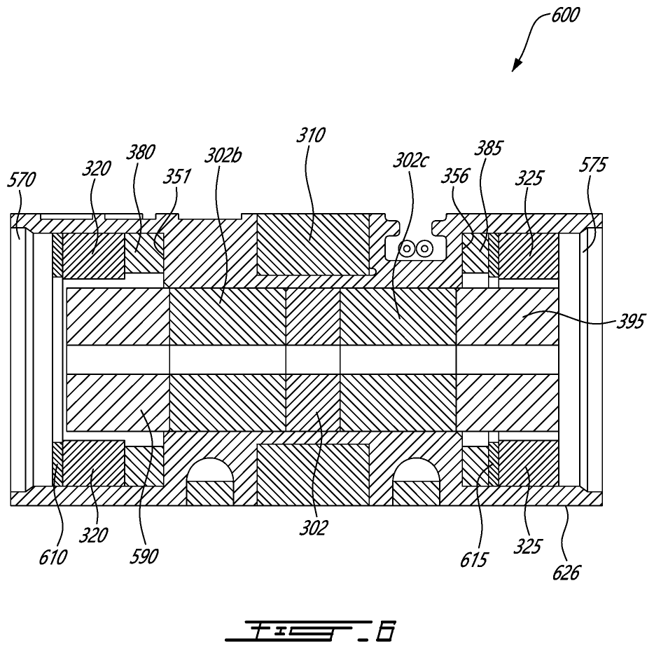

FIG. 5A is a cross-sectional side view of an example linear actuator device 500. As depicted in FIGS. 5A and 5B, linear actuator device 500 includes a housing 526 generally cylindrical in shape. In this embodiment, force elements 320, 325 are permanent magnets and mass 302 includes magnetic elements 302b, 302c. In some embodiments mass 302 may include weights 590, 595. Weights 590, 595 may be included so as to achieve a desired total mass for mass 302, a desired total mass for the linear actuator device, a desired distribution of mass within the linear actuator device, and/or a desired magnitude of acceleration for mass 302. As shown, housing 526 includes threading 556 on an interior surface of cavity 555 and adjustable position element 575 is embodied as a screw cap with threading which engages with the threading 556. Force element 325 is mechanically coupled to screw cap 575 such that rotation of screw cap 575 causes force element 325 to change from a first force element location 565 (as depicted in FIG. 5C) to a different force element location 565′. As depicted in FIGS. 5C and 5D, there is a delta 580 in the locations 565, 565′ of force element 325. The delta 580 in force element location of force element 325 may result in a change in the force response curves, as well as frequency response curves 390, 390′ associated with linear actuator 500, as depicted for example in FIG. 3C.

As depicted in FIGS. 5A-5D, adjustable position element 570 may be a screw cap coupled to force element 320 and may function in a similar manner to adjustable position element 575. That is, adjustable position element 570 may be rotated (whether manually by a user, or by a motor configured to impart rotational movement) and cooperate with threading on an inner surface of housing 526 to displace force element 320 from a first force element location to a second force element location within cavity 550. Moving force element 320 to different force element locations may change the force response curves and/or frequency response curves 390, 390′ associated with linear actuator 500. Although FIGS. 3A, 3B, 4A, 4B, 5A, 5B, 5C and 5D depict embodiments in which two force elements 320, 325 are present and can be located in various force element locations within housing 326, 526, it is contemplated that some embodiments can include only one adjustable position element 375 and that other force elements may have a fixed position within housing 526.

Although embodiments described herein feature a screw cap as adjustable position element 370, 375, it will be appreciated that any manner of adjustable position elements may be used, so long as the position of the adjustable position element may be controlled by a mover. For example, various mechanical, hydraulic and/or pneumatic mechanisms may be used to control a position of adjustable position elements 370, 375. As another example, adjustable position elements 370, 375 do not necessarily need to rotate in order to change a location of force element 320 and can move via linear motion.

In some embodiments, computing device 202 may be configured to perform one or more of activating and de-activating electromagnet 310 to effect movement of mass 302, and/or controlling movement of adjustable position elements 370, 375, 570, 575. In some embodiments, computing device 202 may activate one or more electric motor(s) configured to effect movement (whether rotational, linear, or the like) of one or more adjustable position element(s) 370, 375, 570, 575 which in turn move force element(s) 320, 325 from a first force element location 360, 365 to a second force element location 360′, 365′. In this manner, the force response curve and frequency response curves of linear actuator 204, 300, 400, 500, 600 may be adjusted subsequent to manufacturing.

As depicted in FIGS. 4A and 4B, some embodiments of linear actuator 300, 400, 500 may include a spacer 380. In some embodiments, the spacer 380 is positioned between a stop 351 of housing 326 and force element 320. In this manner, force element 320 may be positioned in a force element location 360 which is based on a thickness 381 of spacer 380 (as the thickness 381 of spacer 380 may prevent force element from being placed any closer to end 351 of cavity 350). For example, as shown in FIGS. 4A and 4B, force element 320 can be moved by adjustable position element 370 from first force element location 360 to second force element location 360′, and cannot be moved any closer to stop 351 due to the thickness 381 of spacer 380. In some embodiments, a spacer 380 may be selected based on the thickness 381 so as to provide a desired force response and/or frequency response curve. For example, the thickness 381 of a spacer may be selected as a function of a desired or required peak frequency for the linear actuator device. As such, rather than modifying the dimensions or a manufacturing process for housing 326 to achieve a desired force response curve and/or frequency response curve, a spacer 380 with a thickness 381 corresponding to a desired frequency response curve and/or force response curve can be selected and placed within the same housing 326 to achieve the desired frequency and/or force response curves, in some embodiments.

In embodiments in which there is not an adjustable position element 370 associated with force element 320, spacer 380 may be inserted into housing 326 after manufacture to position force element 320 in a particular force element location 360′ based on the selected thickness of spacer 380. In some embodiments, spacer 380 may be permanently fixed within housing 326. In some embodiments, spacer 380 may be removably held within housing 326. Spacer 380 may be removed and replaced with another spacer having a different thickness than spacer 380 so as to position force element 320 in a different force element location 360, thus resulting in a different force response curve and/or frequency response curve for linear actuator 300, 400, 500.

In some embodiments, the position of one or more of the force elements 320, 325 may be selected at manufacturing and secured to the housing 326. For example, in some embodiments a tool such as a jig or a robot may be used to set force element 320 in force element position 360 relative to the housing 326. The force element 320 may be secured relative to housing 326 using any suitable method, including the use of adhesives (e.g. glue), welding or the like. Once force element 320 has been secured in the selected position relative to the housing 326 (for example, when the adhesive or weld has set), the jig or robot may then be removed. As such, embodiments are contemplated which include the use of spacers 380, as well as other configurations which do not require the use of spacers 380.

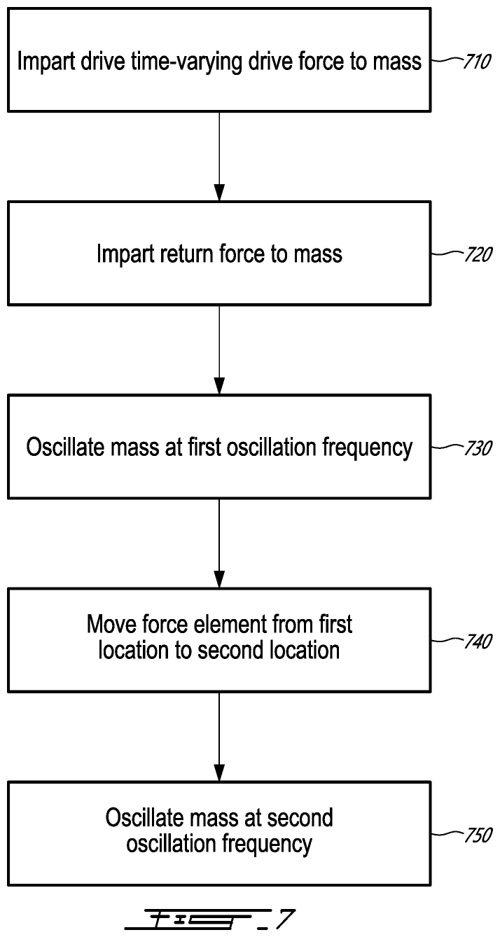

FIG. 6 is a schematic diagram of an example linear actuator device 600 which further includes additional spacers 610, 615, 385 in addition to spacer 380. It will be appreciated that the various embodiments described herein may include one spacer 380, one spacer 385, and/or two or more spacers 380, 385 in accordance with the principles described herein.

As such, if linear actuator device 600 requires tuning or a slight adjustment in configuration in order to achieve the desired force response curve and/or frequency response curve characteristics, one or more spacers 610, 615 may be added and/or removed in between a stop of the housing and the force element 320, 325, such that relatively fine-grain adjustment of force element location 320, 325 is possible in a relatively simple manner.

FIG. 7 is a flow chart depicting an example method of operating an actuator device 300, 400, 500, 600. At block 710, a drive force may be imparted to mass 302. In some embodiments, the drive force is time-varying. Examples of time-varying forces may include square waves and other types of waveforms. In some embodiments, the drive force may be generated by electromagnet 310 being selectively activated and deactivated to exert a force through interaction with the magnetic field of mass 302. The resulting force may cause mass 302 to accelerate along the linear displacement path 324. At block 720, a return force may be imparted to mass 302 when the mass is displaced from a rest position. The return force may be in an orientation of the linear displacement path and towards the rest position. The amplitude of the return force may vary as a function of the position of mass 302 in the linear displacement path 324, in accordance with a force response curve and frequency response curve for the mass 302 in the linear displacement path 324.

In some embodiments, a force and/or frequency response curve of linear actuator 300, 400, 500, 600 may have specific desired characteristics (such as peak response frequency, peak response amplitude, or the like). In some embodiments, a force element location 360 may be chosen for force element 320 at the time of assembly of housing 326, where the selected force element location 360 is selected because it will result in a linear actuator device having the desired force and/or frequency response curve characteristics.

In some embodiments, a spacer 380 may be placed or sandwiched within housing 326 at the time of assembly. For example, the spacer 380 may be positioned between a stop 351 of the housing and the force element 320. The spacer 380 may be selected to have a thickness 381 which will result in force element 320 being positioned in the desired force element location 360 based on the thickness 381 of spacer 380. It is understood that sandwiching a spacer between a stop and the force element 320 implies that there is no unfilled space between the stop and force element 320, but does not necessarily imply direct physical contact between spacer 380 and the stop or force element 320. For example, it is contemplated that in some embodiments, a spacer 380 may be placed in between two other spacers 380 (one spacer being in contact with force element 320, and the other spacer in contact with the stop), and the middle spacer 380 can be said to be sandwiched between force element 320 and the stop.

At block 730, the mass 302 oscillates at a first oscillation frequency as a result of the time-varying drive force and the return forces being applied to mass 302. In some embodiments, the oscillation frequency of mass 302 corresponds to the peak response frequency associated with force elements 320, 325 being located in force locations 360, 365. In some embodiments, the oscillation frequency of mass 302 when force elements 320, 325 are located in force element locations 360, 365 may be a frequency other than the peak response frequency. In some embodiments, the peak response frequency is the desired frequency response characteristic which was used as the basis for selecting the force element location 360 and/or thickness 381 of spacer 380.

At block 740, at least one of the force elements 320, 325 may be moved from first location 360, 365 to a second force element location 360′, 365′. In some embodiments, force element location 360′ may be associated with a second peak response frequency. In some embodiments, the second peak response frequency is lower than the first peak response frequency. In some embodiments, the second peak response frequency is greater than the first peak response frequency. In some embodiments, force element location 360′ may be associated with a different force response curve than force element location 360 (when force element 320 is located therein).

At block 750, the mass 302 oscillates at a second oscillation frequency as a result of the time-varying drive force and the return forces being applied to mass 302. In some embodiments, the second oscillation frequency of mass 302 may correspond to the second peak response frequency associated with force elements 320, 325 being located in force element locations 360′, 365′. In some embodiments, the second oscillation frequency of the mass 302 when force elements 320, 325 are located in force element locations 360′, 365′ may be a frequency other than the second peak response frequency.

As such, it can be said that imparting the time-varying drive force and imparting the return force causes the mass 302 to oscillate within the linear displacement path at a first oscillation frequency when at least one force element 320 is at a first one 360 of a plurality of locations 360, 360′, and causes the mass 302 to oscillate within the linear displacement path at a second oscillation frequency when the at least one force element 320 is at a second one 360′ of the plurality of locations 360, 360′.

In some embodiments, force element location 360 may be changed to force element location 360′ by adjustable position element 370. In some embodiments, adjustable position element 370 is a screw configured to engage with threading in housing 326. In some embodiments, force element 320 is affixed to adjustable position element 370, such that moving adjustable position element 370 causes force element 320 to be moved from force element location 360 to force element location 360′.

It will be appreciated that throughout this disclosure, principles relating to one or more force elements 320, 325, force element locations 360, 365, 360′, 365′, cavities 350, 355, adjustable position elements 370, 375 can be understood to apply to only one of these elements 320, 360, 350, 370, to the other of these elements 325, 365, 355, 375, or to both groups of elements. Moreover, it will be understood that embodiments are contemplated in which more than two groups of such elements are included in a linear actuator device.

Different ones of the force elements introduced above can be combined at different longitudinal positions along the linear displacement path so as to produce additional, varying effects on the mass and allow to tailor the force response curve in accordance with the needs of a specific embodiment. Similarly, the mass can have more than one magnetized segment, and if more than one magnetized segments are present, they can be magnetized in different orientations.

Some embodiments described herein may allow for a single model of haptic actuator, being industrially producible in a manner to reduce production costs, easily adaptable to different situations such as different force response curve characteristics, drive frequencies for electromagnet 310 which may vary from one electronic device manufacturer to another. In some embodiments, the linear actuator device 300, 400, 500 may be adaptable to the aforementioned situations during use within a single electronic device.

The following description explores a number of alternative force elements, the effect they can have on the force response curve, and, in turn the effect they can have on the frequency response curve. It was found that some force elements, and combinations thereof, were better adapted to providing a satisfactorily broader band frequency response spectrum, for instance.

As will be understood, the examples described above and illustrated are intended to be exemplary only.

For instance, other types of linear actuators than haptics actuators can benefit from reactive force paths or force elements such as presented above. Moreover, there are many ways of implementing a linear guide which can provide movement ability of the mass along a linear displacement path while also confining the movement ability along the linear displacement path.

Accordingly, the scope is indicated by the appended claims.

What is claimed is:

1. An actuator device comprising:
a housing defining a linear displacement path;
a mass movably mounted in the housing in the linear displacement path, the mass having a magnetic segment;
an electromagnet fixed relative to the housing and configured to selectively impart an acceleration to said mass in an orientation of said linear displacement path;
a reactive force path generating a return force when the mass is displaced from a rest position, the return force being in the orientation of the linear displacement path towards the rest position, an amplitude of the return force varying as a function of a position of the mass in the linear displacement path in accordance with a force response curve, the force response curve defining a frequency response curve in relationship with the frequency of movement of the mass in the linear displacement path;
wherein the housing has a plurality of force element locations for receiving a force element of the reactive force path, a peak response frequency of the frequency response curve varying from one of the force element locations to another, the force element being held at one of the force element locations.

2. The actuator device of claim 1, further comprising an adjustable position element holding the force element, the adjustable position element movable to change the force element location among the plurality of force element locations.

3. The actuator device of claim 2, wherein the force element is a magnet secured to the adjustable position element, and the adjustable position element moves the magnet.

4. The actuator device of claim 2, wherein the force element is a spring having two opposite ends, one of the ends secured to the adjustable position element, and the adjustable position element moves a position of the one of the ends.

5. The actuator device of claim 1, further comprising a spacer positioned between a stop of the housing and the force element, the spacer holding the force element at the one of the force element locations based on a thickness of the spacer.

6. The actuator device of claim 5, wherein the spacer is interchangeable with another spacer to hold the force element at a different one of the plurality of force element locations based on a thickness of the another spacer.

7. The actuator device of claim 1, wherein the magnetic segment comprises two permanent magnets spaced apart by a ferromagnetic material.

8. The actuator device of claim 2, wherein each of the plurality of force element locations is associated with respective force response curves.

9. The actuator device of claim 2, wherein the adjustable position element is a screw and the housing includes threading for receiving the screw.

10. The actuator device of claim 2, further comprising a mover configured to effect movement of the adjustable position element.

11. The actuator device of claim 10, wherein the mover is controlled by a computing device.

12. The actuator device of claim 5, wherein the spacer is a washer.

13. A method of operating an actuator device having a mass movably mounted in a linear displacement path defined relative a housing, the actuator device further having a reactive force path having a plurality of force elements including at least one force element having a plurality of locations defined relative the housing, the method comprising:
imparting a time-varying drive force to the mass in an orientation of the linear displacement path at a first drive frequency,
the reactive force path imparting a return force to the mass when the mass is displaced along the linear displacement path away from a rest position, the return force being in the orientation of the linear displacement path and towards the rest position, the amplitude of the return force varying as a function of the position of the mass in the linear displacement path in accordance with a force response curve, the force response curve defining a frequency response curve for the mass in the linear displacement path, and
moving said at least one force element from a first one of said plurality of locations to a second one of said plurality of locations;
wherein said imparting of the time-varying drive force and the imparting of the return force oscillates the mass within the linear displacement path at a first oscillation frequency when the at least one force element is at the first one of said plurality of locations, and oscillates the mass within the linear displacement path at a second oscillation frequency when the at least one force element is at the second one of the plurality of locations.

14. The method of claim 13, wherein the moving the at least one force element from the first one of said plurality of locations to a second one of said plurality of locations comprises moving an adjustable position element coupled to said at least one force element.

15. The method of claim 14, wherein said at least one force element is a magnet secured to the adjustable position element.

16. The method of claim 14, wherein said at least one force element is a spring having two opposite ends, one of the ends secured to the adjustable position element, and the adjustable position element moves a position of one of the ends.

17. The method of claim 14, wherein the adjustable position element is a screw and the housing includes threading for receiving the screw.

18. A method of assembling an actuator device having a mass movably mounted in a linear displacement path defined relative a housing, the actuator device further having a reactive force path having a plurality of force elements including at least one force element having a plurality of locations defined relative the housing, the method comprising:
selecting, from amongst a plurality of spacers having different thicknesses associated to different ones of said plurality of locations, one of said spacers corresponding to a respective one of said plurality of locations; and
sandwiching said selected spacer between a corresponding one of said force elements and a stop of the housing, said selected spacer setting a location of the force element to said one of said plurality of locations.

19. The method of claim 18, further comprising:
removing said selected spacer from between said corresponding one of said force elements and said stop of said housing,
selecting another one of said spacers corresponding to another respective one of said plurality of locations, and
sandwiching said selected another one of said spacers between the corresponding one of said force elements and said stop of the housing, said selected another one of said spacer setting the location of the force element to said another respective one of said plurality of locations.

20. The method of claim 18, further comprising:
imparting a time-varying drive force to the mass in an orientation of the linear displacement path;
the reactive force path imparting a return force to the mass when the mass is displaced along the linear displacement path away from a rest position, the return force being in the orientation of the linear displacement path towards the rest position, the amplitude of the return force varying as a function of the position of the mass in the linear displacement path in accordance with a force response curve, the force response curve defining a frequency response curve for the mass in the linear displacement path; and
said imparting of the time-varying drive force and the imparting of the return force oscillating the mass within the linear displacement path at a first oscillation frequency when said at least one force element is at said one of said plurality of locations.
